(19) United States
(12) Patent Application Publication
(10) Pub. No.: US 2019/0376713 A1
(43) Pub. Date: Dec. 12, 2019

(54) ENERGY MANAGEMENT SYSTEM AND ENERGY MANAGING METHOD

(71) Applicants: Hitachi, Ltd., Tokyo (JP); The University of Tokyo, Tokyo (JP)

(72) Inventors: Naoki YOSHIMOTO, Tokyo (JP); Yasunori AKASHI, Tokyo (JP); Shohei MIYATA, Tokyo (JP); Yasuhiro KUWAHARA, Tokyo (JP)

(21) Appl. No.: 16/424,877

(22) Filed: May 29, 2019

(30) Foreign Application Priority Data
Jun. 12, 2018 (JP) 2018-111775

(51) Int. Cl. F24F 11/47; G06N 5/02; G05B 19/042; G06Q 50/06; F24F 11/56; F24F 11/64; F24F 11/65; F24F 11/80; F24F 11/84; F24F 11/85; F24F 11/86

(52) U.S. Cl. CPC F24F 11/47; G06N 5/02; G05B 19/042; G06Q 50/06; F24F 11/56; F24F 11/64; F24F 2110/12; F24F 11/80; F24F 11/84; F24F 11/85; F24F 11/86; G05B 2219/2639; G05B 2219/2614; F24F 11/65

(57) ABSTRACT

An energy management system has a prediction unit that determines an effective management pattern and predicts a DR demand amount and a reception unit that prepares a control plan and determines a DR response amount from a power consumption amount, and the reception unit prepares individual control plans for (1) minimizing the sum of power consumption amounts of a cooling tower and refrigerators without changing an amount of heat, (2) improving efficiency of the refrigerators by increasing a cold water temperature at an outlet of one refrigerator, (3) stopping an operation of one refrigerator, (4) reducing motive power of the pump and (5) operating an alternative facility and stopping the operation of one refrigerator, combines together the prepared individual control plans and prepares a control plan that satisfies the predicted DR demand amount.

### CLAIM OF PRIORITY

The present application claims priority from Japanese patent application JP 2018-111775 filed on Jun. 12, 2018, the content of which is hereby incorporated by reference into this application.

### BACKGROUND

The present invention relates to an energy management system which manages a (an electric) power demand by using a technology which is called Demand Response (hereinafter, referred to as the demand response) and an energy managing method that the energy management system executes.

Issues pertaining to stabilization of a power transmission frequency and control of power demand and supply balance are becoming apparent in association with expanded introduction of variable and renewable energies which are obtained from photovoltaic power generation, wind power generation and so forth. The technology which is called the demand response that a consumer complies with stabilization of the power demand and supply is given as one of technologies for taking measures against duck curves and stabilizing the power transmission frequency in the photovoltaic power generation. There are negawatt trading which suppresses a rapid increase in power demand and posiwatt trading which positively uses the surplus renewable energy in the demand response (in the following, also referred to as DR). In the present situation, the demand response is limited to request for cooperation to large consumers of designated types of business who owe factories and so forth in each of which the power demand in a time zone that the next day tight power demand and supply balance and so forth are forecasted in advance is predictable.

As a background art of this technical field, there is the following related art. In Japanese Unexamined Patent Application Publication No. 2013-141331, there is described a power management system which has consumer terminals which are provided for respective consumers and a power management device which is connected to the respective consumer terminals, each of the consumer terminals is equipped with a meteorological forecast acquisition unit which acquires local meteorological prediction of an area around the consumer concerned and a power prediction unit which predicts power consumption and a reducible electric power amount in a time period which is predicted in the meteorological prediction on the basis of the meteorological prediction, and the power management device is equipped with an integration unit which respectively integrates the power consumptions and the power amounts which are calculated by the respective consumer terminals and calculates the total power consumption and the total reducible power amount of all the consumers.

### SUMMARY

Positive participation of not only the large consumers of the designated types of business but also operational divisions such as large buildings, shopping malls and so forth in the demand response like this is desirable. However, use application of the electric power covers a wide range in the operational divisions and there are many restrictions to participation of the operational divisions in the demand response. In addition, since the use application of the power covers the wide range in the operational divisions, it is necessary to evaluate the influence which would occur when participating in the demand response. However, there is no evaluation method.

The present invention has been made in view of the abovementioned circumstances and aims to provide an energy management system which creates negawatt power by reducing the power demand of an air conditioning system of a building and makes participation in the demand response possible by effective management of an existing facility and an energy managing method that the energy management system executes.

A representative example of the invention which is disclosed in the present patent application is as follows. That is, according to one aspect of the present invention, there is provided an energy management system which controls an operation of an air conditioning facility and is equipped with an arithmetic operation device which realizes the following respective function units by executing processing in accordance with predetermined procedures and a storage device which is connected to the arithmetic operation device, in which the air conditioning facility includes a cooling tower which cools cooling water, refrigerators which cool cold water, a pump which works to circulate the cold water, and a valve which is disposed in a flow path of the cold water, the energy management system further including a prediction unit which determines one effective management pattern which is similar to a current effective management state in past effective management data of the air conditioning facility and predicts a DR demand amount on the basis of a weather forecast and the past effective management data of the air conditioning facility, and a reception unit which prepares a control plan for the air conditioning facility by using the determined effective management pattern and determines a DR response amount depending on a power consumption amount in the control plan as the function units, and the reception unit prepares at least one of individual control plans for (1) minimizing the sum of power consumption amounts of the cooling tower and the refrigerator without changing an amount of heat that the refrigerator generates by controlling an operation of the cooling tower, (2) improving efficiency of the refrigerator by increasing a cold water temperature at an outlet of the refrigerator, (3) stopping an operation of at least one of the refrigerators, (4) controlling operations of the valve and the pump to reduce motive power of the pump, and (5) operating an alternative facility and stopping the operation of at least one of the refrigerator, combines the prepared individual control plans with one another in order of the plans (1) to (5), and thereby prepares a control plan which satisfies the predicted DR demand amount.

According to one aspect of the present invention, it becomes possible to reduce the power demand by creating the negawatt power by utilizing an air conditioning system of each building. Issues, configurations and effects other than the above will become apparent from the following description of one embodiment.

### BRIEF DESCRIPTION OF THE DRAWINGS

FIG. 1 is a diagram illustrating one example of a reduction in power demand in demand response.

FIG. 2 is a block diagram illustrating one logical configuration example of an energy management system according to one embodiment of the present invention.

FIG. 3 is a block diagram illustrating one physical configuration example of the energy management system according to the present embodiment.

FIG. 4A is a diagram illustrating one example of control of cold water.

FIG. 4B is a diagram illustrating one example of control of cooling water.

FIG. 5A is a graph illustrating one example of a relation among a load factor, efficiency and a cooling water inlet temperature.

FIG. 5B is a graph illustrating one example of a relation among the load factor, the efficiency and a cooling water outlet temperature.

FIG. 6 is a flowchart illustrating one example of processing that a prediction unit executes.

FIG. 7 is a graph illustrating one example of a method of predicting an energy demand of a building.

FIG. 8 is a flowchart illustrating one example of processing that an acceptance unit executes.

FIG. 9 is a flowchart illustrating one example of processing that a calculation unit executes.

FIG. 10 is a flowchart illustrating one example of processing that a restoration unit executes.

FIG. 11 is a graph illustrating one example of a relation between an operation of equipment to be controlled and power consumption thereof.

### DETAILED DESCRIPTION

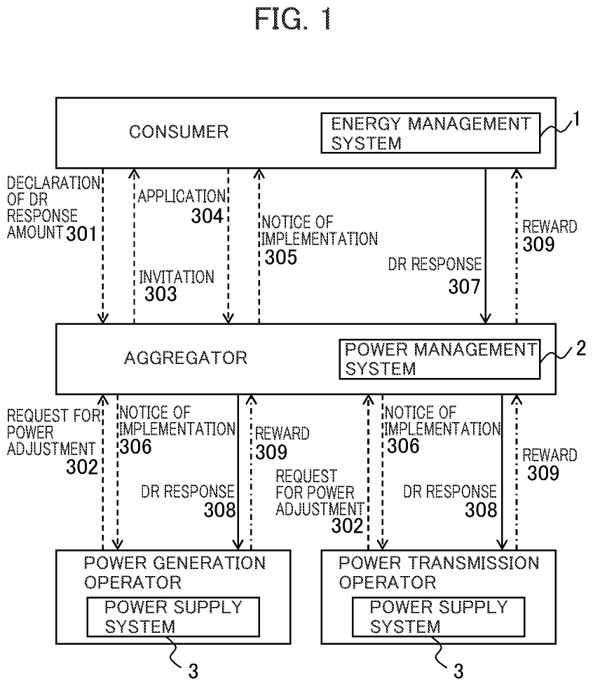

FIG. 1 is a diagram illustrating one example of a reduction in (electric) power demand which is necessary for implementation of Demand Response (hereinafter, referred to as the demand response). Incidentally, in FIG. 1, a solid line indicates movement of electric power (negawatt power), a broken line indicates transfer of information (a control command, a response and so forth) and a dashed line indicates movement of a monetary value. In addition, the information is transmitted and received between systems that respective persons possess.

As one aspect of the demand response which is used to fluctuate a power demand amount of a consumer so as to maintain a balance between demand and supply of the electric power, there is a format that an aggregator which relays between an electric power company (a power generation business operator, a power transmission business operator) and the consumer aggregates a plurality of consumers and adjusts power demand and supply at an energy transaction market.

The consumer concerned declares a DR (demand response) response amount in advance for cooperation in a reduction in power demand (301) and the aggregator registers the declaration of the consumer.

In a case where the reduction in power demand is necessary, the electric power company requests the aggregator to adjust the power so as to reduce the power demand (302). The aggregator invites the consumer whose declaration is registered so as to reduce the demand amount by implementation of the demand response (303). The consumer applies for the demand response (304). In this case, when a really achievable DR response amount is different from the response amount which is declared in advance, the consumer may declare the DR response amount to the aggregator.

The aggregator adds up the DR response amounts which are declared from the respective consumers, prepares a demand response plan which reacts to a power adjustment request from the electric power company and gives the consumers a notice of adoption/rejection of the demand response (performs power adjustment on the consumer who is adopted) (305). In addition, the aggregator transmits an implementation notice for informing the electric power company that implementation of the demand response is possible (306). Incidentally, the electric power company may decide cooperators (the aggregator, the consumers and so forth) in the power demand reduction depending on a result of bidding by the plurality of aggregators.

Each consumer reduces the power demand at a timing that the consumer is requested to adjust the power and gives a DR response (negawatt power) to the aggregator (307). The aggregator gives the DR response (the negawatt power) given from the consumer to the electric power company (308). Then, the electric power company gives a reward to the consumer who complies with the power demand reduction via the aggregator (309).

In control of the power amount which is based on the above-described demand response, each consumer installs and operates an energy management system 1 according to one embodiment of the present invention. The energy management system 1 may be either a system which monitors and controls air condition, hot-water supply, power supply and so forth of one building or a system which monitors and controls in an integrated manner the air condition, the hot-water supply, the power supply and so forth of neighboring buildings. The aggregator operates a power management system 2. The power generation business operator and the power transmission business operator have power supply systems 3.

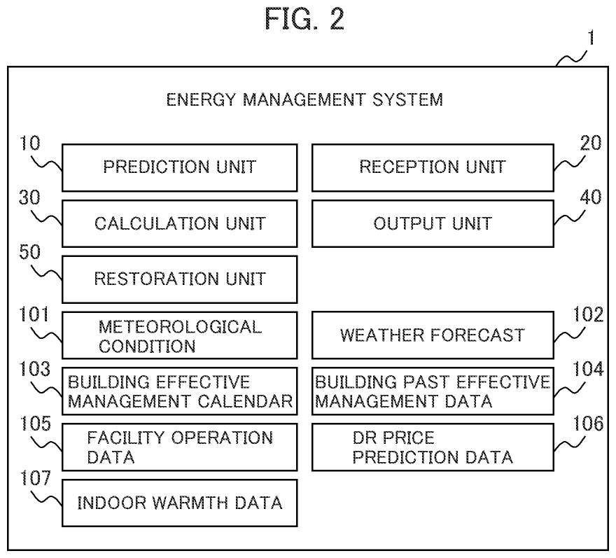

FIG. 2 is a block diagram illustrating one logical configuration example of the energy management system 1 according to one embodiment of the present invention.

The energy management system 1 according to the present embodiment includes a prediction unit 10, a reception unit 20, a calculation unit 30, an output unit 40 and a restoration unit 50 as function units and manages an operation of an energy consuming facility such as an air conditioning facility and so forth of a building to be managed. The energy management system 1 may manage hot-water supply, lighting and so forth of the building.

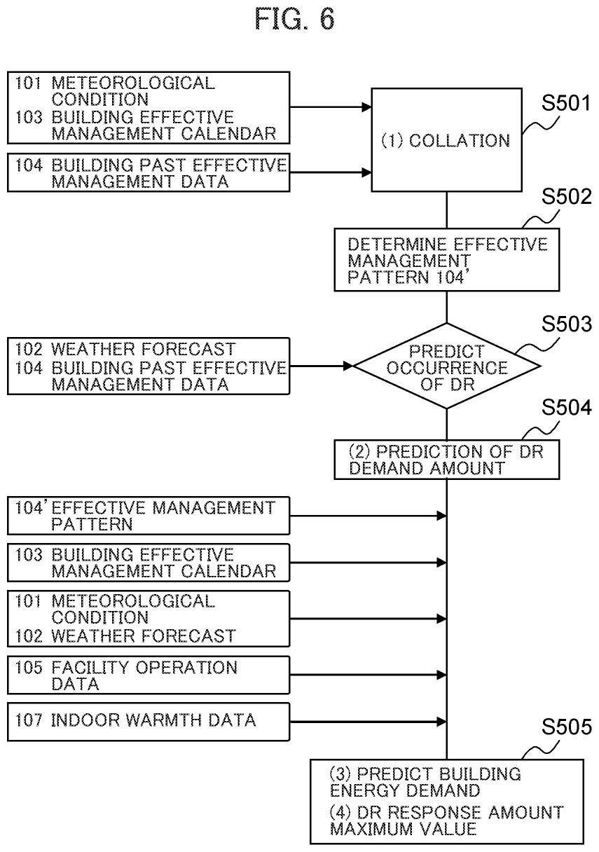

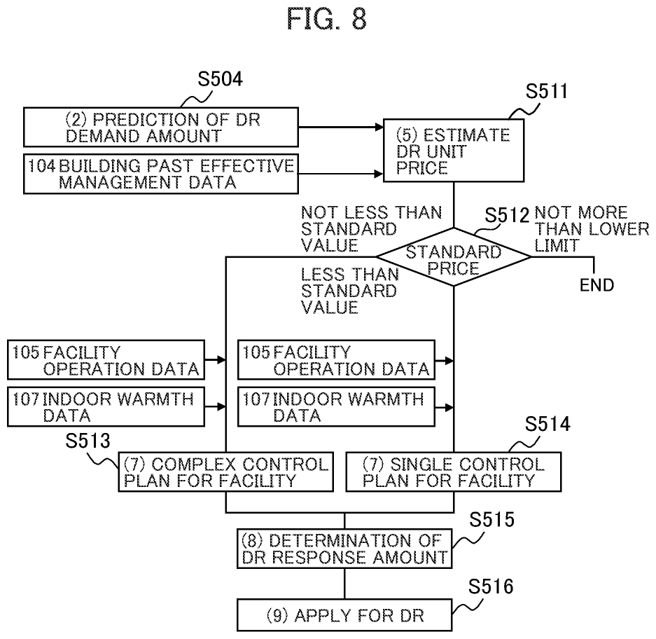

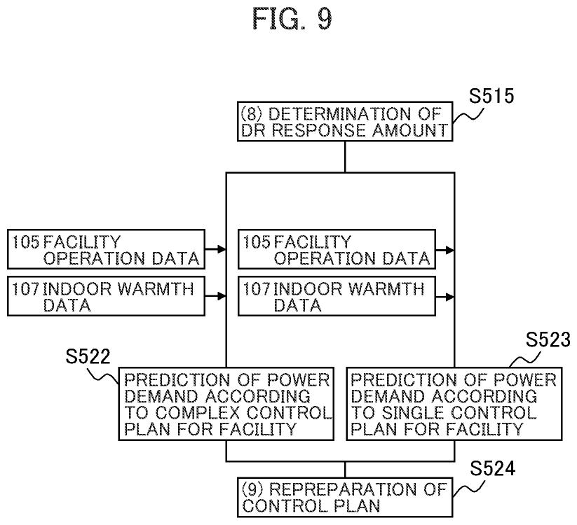

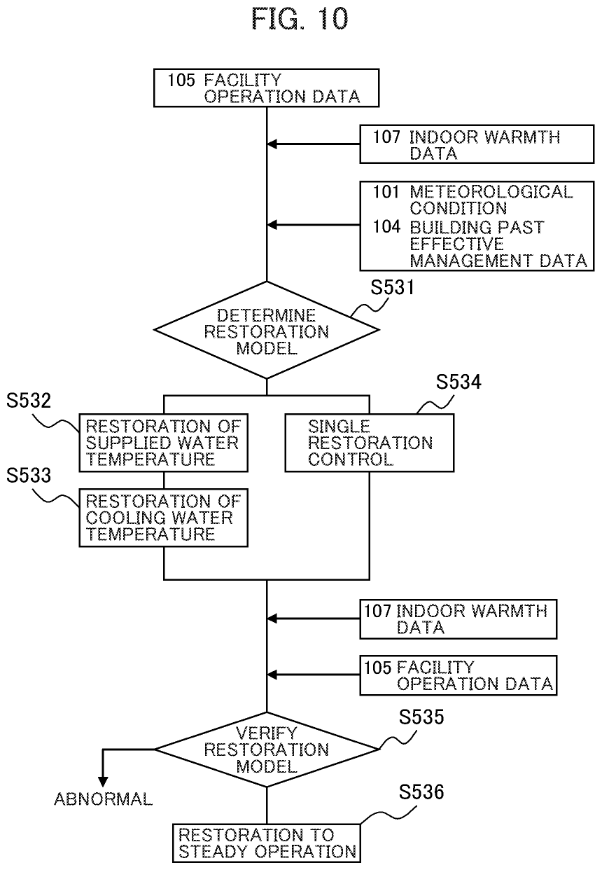

The prediction unit 10 predicts the power demand when the demand response is implemented and calculates a DR response maximum amount which is a maximum value of the negawatt power which is created by implementing the demand response. Details of processing that the prediction unit 10 executes will be described later by using FIG. 6. The reception unit 20 prepares a control plan used for implementation of the demand response. Details of processing that the reception unit 20 executes will be described later by using FIG. 8. The calculation unit 30 predicts the power demand in implementation of the demand response. Details of processing that the calculation unit 30 executes will be described later by using FIG. 9. The output unit 40 transmits a command to the aggregator (the power management system 2) and generates a screen which displays the effect which is brought about by the demand response. The restoration unit 50 performs control of restoration from the demand response and verifies an operation state of the aforementioned air conditioning facility which is being subjected to restoration control. Details of processing that the restoration unit 50 executes will be described later by using FIG. 10.

In addition, the energy management system 1 includes meteorological condition (data) 101, weather forecast (data) 102, building effective management calendar (data) 103, building past effective management data 104, facility operation data 105, DR price prediction data 106 and indoor warmth data 107 as the data that the respective function units use when executing the processing. These pieces of data are stored into an auxiliary storage device 203 and a memory 202 which will be described later. Alternatively, these pieces of data may be stored into an external storage device.

The meteorological condition 101 includes meteorological data on the weather (clear weather, cloudiness, rain, snow and so forth), temperatures, humidity and so forth and these pieces of the meteorological data are measured in and around a building concerned and/or acquired from a meteorological forecasting company (a forecast business authorized operator). The weather forecast 102 is the forecast of the meteorological condition (the weather, the temperatures, the humidity and so forth) which will be observed after a predetermined time has elapsed and is acquired from the Meteorological Agency, the meteorological forecasting company and so forth.

The building effective management calendar 103 includes data on the contents and dates and times of events which will be held in the building concerned. The building past effective management data 104 includes data on the air conditioning facility in the building, the power consumption amount of the facility concerned, actual results of the DR response and the meteorological phenomenon of the location of the building concerned. The meteorological data is acquired from the Meteorological Agency, the meteorological forecasting company and so forth. In the building past effective management data 104, the past effective management data is accumulated in a log format and, in addition, effective management patterns and restoration patterns which are prepared by classifying the past effective management data are also included in the building past effective management data 104. Incidentally, the effective management patterns and the restoration patterns may be prepared by searching for similar log data each time without preparing in advance the effective management patterns and the restoration patterns.

The facility operation data 105 indicates an operational status of the air conditioning facility in the building concerned and includes data on supplied water temperatures, cooling water temperatures, operation states of valves and pumps, the number of refrigerators in operation and so forth. The DR price prediction data 106 is actual result data on the past implemented demand response and is data from which it is found that the demand response was implemented under which condition (the meteorological condition, the event and so forth) and at what price. The DR price prediction data 106 is data which is obtained by accumulating the actual results of the prices of the past demand response in the log format. Alternatively, data which is obtained by patterning the prices of the past demand response may be held. The indoor warmth data 107 includes data on indoor temperatures and humidity in the building and may also include data pertaining to person's sense and behavior (for example, warmth indexes (an effective temperature, a discomfort index, a warm-cold sense index and so forth), a feeling temperature, a warm-cold sense, comfortability, a sense of the seasons, a clothing amount and so forth.

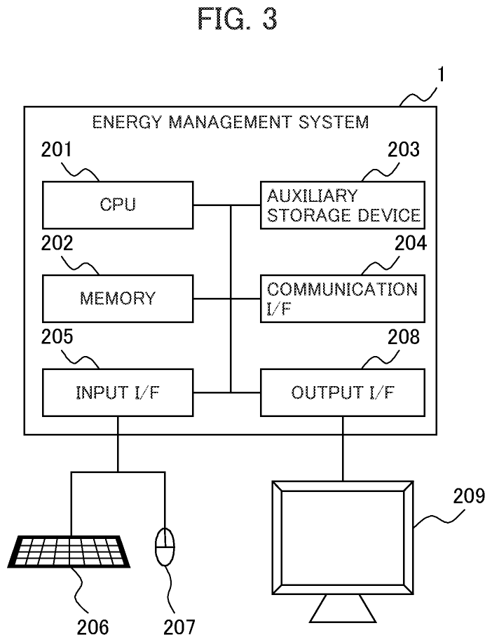

FIG. 3 is a block diagram illustrating one physical configuration example of the energy management system 1 according to the present embodiment.

The energy management system 1 according to the present embodiment is configured by a computer which includes a processor (CPU) 201, the memory 202, the auxiliary storage device 203, a communication interface 204, an input interface 205, an output interface 208 and so forth.

The processor 201 is an arithmetic operation device which executes various programs stored in the memory 202. The processor 201 executes the various programs and thereby various functions of the energy management system 1 are implemented. Incidentally, part of processing that the processor 201 performs by executing the programs maybe executed by another arithmetic operation device (for example, an FPGA (Field-Programmable Gate Array)).

The memory 202 includes a ROM (Read Only Memory) which is a nonvolatile storage element and a RAM (Random Access Memory) which is a volatile storage element. The ROM stores therein an immutable program (for example, a BIOS (Basic Input Output System)) and so forth. The RAM is the high-speed and volatile storage element such as a DRAM (Dynamic Random Access Memory) and temporarily stores therein the programs that the processor 201 executes and data which is used in execution of the programs.

The auxiliary storage device 203 is a large-capacity and nonvolatile storage device such as, for example, a magnetic storage device (an HDD (Hard Disk Drive)), a flash memory (an SSD (Solid State Drive)) and so forth. In addition, the auxiliary storage device 203 stores therein data that the processor 201 uses in execution of the programs (for example, the current meteorological condition 101, the weather forecast 102, the building effective management calendar 103, the building past effective management data 104, the facility operation data 105, the DR price prediction data 106, the indoor warmth data 107 and so forth) and programs (for example, a prediction program, a reception program, a calculation program, an output program, a restoration program and so forth) that the processor 201 executes. That is, the programs are read out of the auxiliary storage device 203, loaded into the memory 202 and executed by the processor and thereby the respective functions of the energy management system 1 are implemented.

The communication interface 204 is a network interface device which controls communications with other devices in accordance with a predetermined protocol.

The input interface 205 is an interface to which input devices such as a keyboard 206, a mouse 207 and so forth are connected so as to receive an input from an operator. The output interface 208 is an interface to which output devices such as a display device 209, a printer (not illustrated) and so forth are connected so as to output a result of execution of the program concerned in a format that the operator is visually recognizable. Incidentally, a terminal which is connected to the energy management system 1 over a network may serve as the input device and the output device.

The programs that the processor 201 executes are provided to the energy management system 1 via removable media (such as a CD-ROM, the flash memory and so forth) or over the network and are stored into the nonvolatile auxiliary storage device 203 which is a non-transitory storage medium. Therefore, it is preferable for the energy management system 1 to have an interface which is used to read data out of the removable media into the energy management system 1.

The energy management system 1 is a computer system which is physically configured on one computer or configured on a plurality of logically or physically configured computers and may operate on a virtual computer which is constructed on a plurality of physical computer resources.

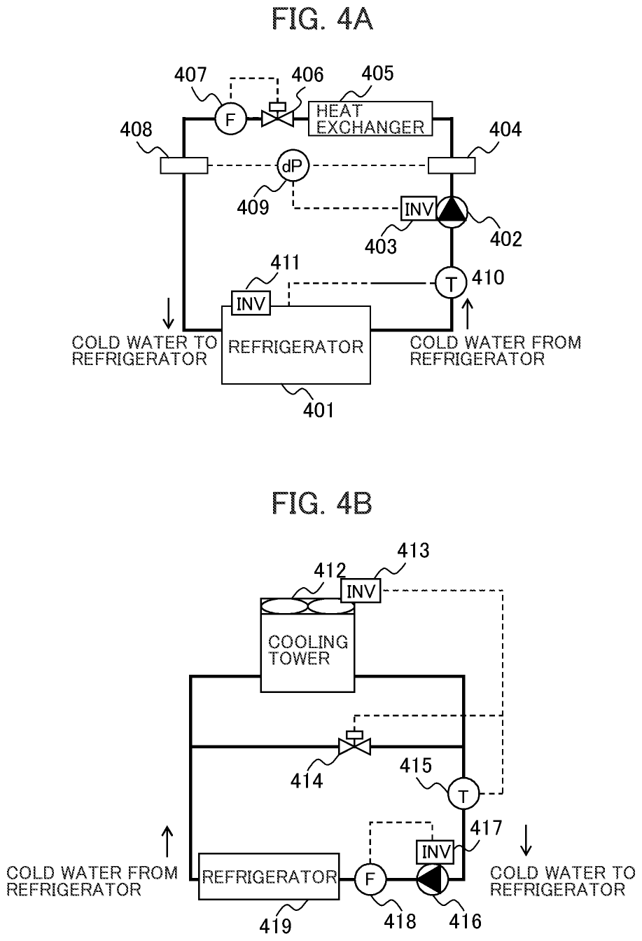

FIG. 4A is a diagram illustrating one example of control of cold water.

The cold water which is cooled in a refrigerator (for example, a turbo refrigerator) 401 is sent to a heat exchanger 405 with the aid of a pump 402. The pump 402 is controlled by an inverter 403 in such a manner that a header-to-header differential pressure 409 which is a differential pressure between headers 404 and 408 reaches a set value. The heat exchanger 405 cools air for air condition with the cold water which is supplied from the refrigerator 401. A valve 406 and a flowmeter 407 are disposed in a flow path (on the downstream side of the heat exchanger 405 in FIG. 4A) of the cold water and an opening of the valve 406 is controlled in such a manner that a measured value of the flowmeter 407 reaches a set value. For example, when the header-to-header differential pressure 409 is reduced, a lifting height which is necessary for the pump 402 is reduced and thereby it becomes possible to reduce the power consumption. In this case, the valve 406 is appropriately controlled and thereby the cold water is supplied by a required amount. However, in a case where a sufficiently high lifting height is not attained even when the valve 406 is fully opened, the suppled water amount is reduced.

In addition, a thermometer 410 is disposed in the flow path of the cold water. Cooling capability of the refrigerator 401 is controlled by an inverter 411 and the temperature of the cold water which is sent out of the refrigerator 401 is controlled in accordance with a measured value of the thermometer 410. The temperature of the cold water is the supplied water temperature of the system in FIG. 4A relative to the heat exchanger 405.

FIG. 4B is a diagram illustrating one example of control of cooling water.

A cooling tower 412 sends out the cooling water which is cooled to, for example, 24° C. The cooling water which is sent out of the cooling tower 412 is introduced into a refrigerator 419 and is heated to a higher temperature (for example, 30° C.) with waste heat which is generated as a result of production of the cold water in the refrigerator 419 and then is sent out. A flow rate of the cooling water is controlled by an inverter 417 in such a manner that a measured value of a flowmeter 418 reaches a set value.

Further, a bypass flow path which guides the cooling water to circulate without passing through the cooling tower 412 is disposed in the flow path of the cooling water and, in addition, a valve 414 adapted to control an amount of the cooling water which flows to the bypass flow path is disposed in the flow path of the cooling water. It is possible to control a temperature 415 of the cooling water which flows into the refrigerator 419 by controlling the operation of a fan inverter 413 of the cooling tower 412 and an opening of the valve 414.

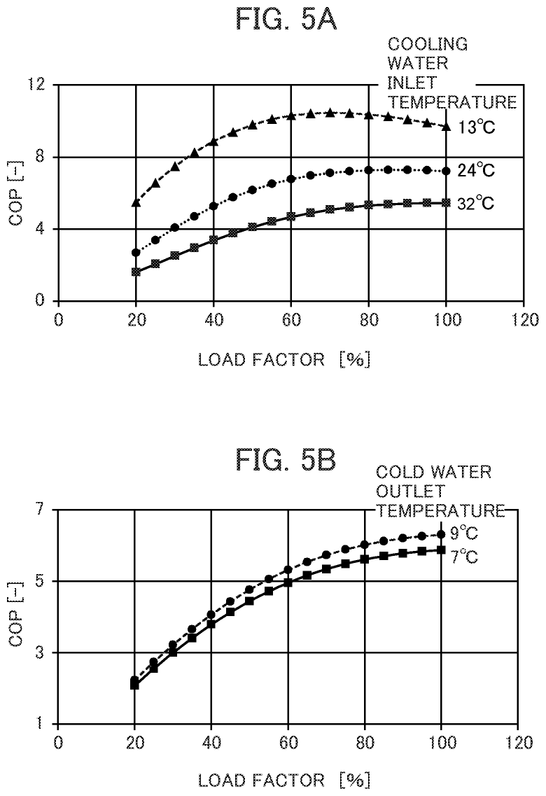

FIG. 5A is a graph illustrating one example of a relation between a load factor and efficiency of the refrigerator 419 at each temperature of the cooling water which flows into the refrigerator 419. In a case where the load factor of the refrigerator 419 is not changed, when a temperature (the temperature of the cooling water at an inlet of the refrigerator 419) of the cooling water which flows into the refrigerator 419 is reduced, the efficiency (COP (Coefficient Of Performance)) of the refrigerator 419 is improved and thereby a reduction in power consumption becomes possible. Specifically, it becomes possible to improve the COP of the refrigerator 419 by operating a fan of the cooling tower 412 for a time period which is longer than usual so as to reduce the cooling water temperature. In this case, motive power of the fan of the cooling tower 412 is increased and therefore is controlled so as to reach an optimum point.

FIG. 5B is a graph illustrating one example of a relation between a load factor and efficiency of the refrigerator 401 at each temperature of the cold water which is discharged from the refrigerator 401. In a case where the load factor of the refrigerator 401 is not changed, when a temperature (the temperature of the cold water at an outlet of the refrigerator 401) which is discharged from the refrigerator 401 is increased, the efficiency (COP) of the refrigerator 401 is improved and thereby the reduction in power consumption becomes possible.

FIG. 6 is a flowchart illustrating one example of processing that the prediction unit 10 executes.

The processor 201 activates the prediction unit 10 in accordance with the prediction program and thereby the prediction unit 10 executes prediction processing. The prediction processing is repetitively executed at predetermined timings in preparation for the demand response to be implemented after the elapse of a predetermined time (for example, 30 minutes).

First, the prediction unit 10 collates the current meteorological condition 101 and the building effective management calendar 103 with the building past effective management data 104 (S501) and determines an effective management pattern 104′ which is included in the building past effective management data 104 and is similar to the current effective management state on the basis of the current meteorological condition 101 and the building effective management calendar 103 (S502). In a case where the building past effective management data 104 is patterned, a similar patterned effective management pattern may be selected. In a case where the building past effective management data 104 is in the log format, a similar logged effective management pattern is selected and is determined as the effective management pattern.

Next, the prediction unit 10 predicts occurrence of the demand response from the weather forecast 102 and the building past effective management data 104 (S503) and predicts the DR demand amount (S504). Specifically, the prediction unit 10 selects a condition which is similar to that of the weather forecast for the weather which will be observed after the elapse of a predetermined time from the building past effective management data 104 and calculates a ratio (an occurrence rate) that the demand response is requested in the selected data. In this case, the prediction unit 10 may calculate the occurrence rate of the demand response by taking a characteristic change of the power demand depending on the calendar (days of the week, national holidays, the O-bon festival, the New Year holidays, and events such as live concerts, sports and so forth) into consideration. Then, the prediction unit 10 calculates a statistic value (for example, a mean value) of the DR (demand response) demand amounts in the selected data and sets the calculated value as a predicted value of the DR demand amount.

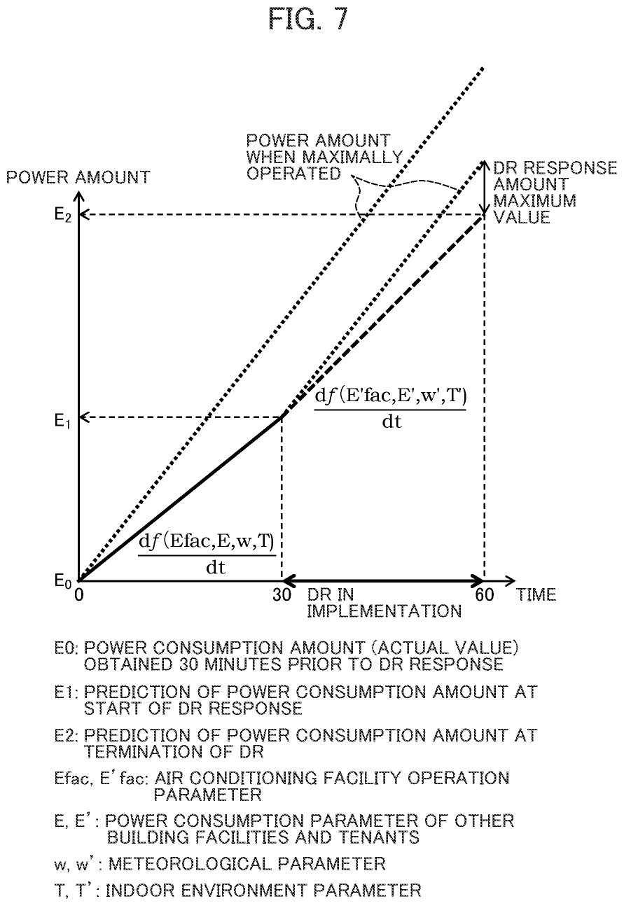

Then, the prediction unit 10 predicts the power demand of the building concerned and calculates a DR response maximum value (S505). The prediction unit 10 linearly predicts the power demand at the start of implementation of the demand response by using, for example, the selected effective management pattern 104′, the current meteorological condition 101, the weather forecast 102, the building effective management calendar 103, the facility operation data 105 and the indoor warmth data 107. FIG. 7 is a graph illustrating one example of a method of predicting an energy demand of the building concerned.

Functions f (Efac, E, w, T) used for calculation of an electric power amount are set and an electric power amount E1 which is consumed until start of implementation of the demand response (after the elapse of 30 minutes in the example in FIG. 7) with a time-dependent change (df/dt) of the function f being plotted as an inclination. “Efac” which is an explanatory variable of the function f is an operation parameter of the air conditioning facility concerned, “E” is a power consumption amount of other facilities, “w” is a meteorological parameter, and “T” is an indoor environment parameter. One of the warmth indexes (for example, the effective temperature, the discomfort index, the warm-cold sense index and so forth) may be used as the indoor environment parameter, in addition to measurable physical amounts such as the temperature, the humidity and so forth. The plurality of parameters may be used for each kind of the respective explanatory variables. For example, in a case where the power consumption amount is used as the operation parameter Efac of the air conditioning facility, one parameter may be used as the parameter which configures “Efac”. On the other hand, in a case of using the supplied water temperature, the cooling water temperature, the operation states of the valve and the pump, the number of the refrigerators in operation and so forth, the plurality of parameters configure “Efac”.

Then, a power demand while the demand response is being implemented is predicted. In general, the power demand becomes tight and various environmental changes occur while the demand response is being implemented. For this reason, the parameters are different from those used before implementation of the demand response is started and the electric power amount per unit time changes. Therefore, an electric power amount E2 to be consumed until termination of implementation of the demand response is calculated with the time-dependent change (df/dt) of the function f using parameters Efac′, E′, w′, and T′ in the operation pattern 104′ which is determined in step S502 being plotted as the inclination, differently from the calculation before implementation of the demand response is started. Incidentally, although in the illustrated graph of the predicted value of the electric power mount, the electric power amount per unit time is increased while the demand response is being implemented, there are cases where the electric power amount per unit time is reduced.

Then, the maximum value of the DR response amount is predicted. The maximum value of the DR response amount is indicated by a difference between the electric power amount at the time of maximum operation and the power demand while the demand response is being implemented.

FIG. 8 is a flowchart illustrating one example of processing that the reception unit 20 executes.

When the prediction unit 10 predicts the DR demand amount (S504), the processor 201 activates the reception unit 20 in accordance with the reception program and the reception unit 20 executes reception processing.

First, the reception unit 20 estimates the DR unit price by using the predicted value of the DR demand amount and the building past effective management data 104 (S511). The reception unit 20 selects, for example, data for which the demand response is implemented in the data selected in prediction of the DR demand amount in step S504, calculates a statistic value (for example, a mean value) of the unit price of the demand response, estimate the DR unit price and selects a unit price which is similar to the estimated DR unit price in condition from the DR price prediction data 106.

Then, the reception unit 20 compares the estimated DR unit price with a standard price which is determined in advance (S512). The standard price is a standard price which is determined in advance by the consumer concerned in accordance with an investment value and an effective management cost of the air conditioning facility concerned and indicates profit and loss relative to the demand response and includes a standard value and a lower limit value. Then, in a case where the estimated DR unit price is not more than the lower limit value, the reception unit 20 terminates execution of the reception processing because implementation of the demand response brings no merit to the consumer and the customer does not apply for invitation of the demand response even when invited.

On the other hand, in a case where the estimated DR unit price is not less than the standard value, the reception unit 20 prepares a complex control plan use to control the operations of the plurality of facilities with reference to the facility operation data 105 and the indoor warmth data 107 (S513) because the profit which is brought about by implementation of the demand response is large and it is necessary to increase a reduction amount (a negawatt power creation amount) of the power demand. In addition, in a case where the estimated DR unit price is lower than the standard value, the reception unit 20 prepares a single control plan used to control one kind of the facility with reference to the facility operation data 105 and the indoor warmth data 107 because the profit which is brought about by implementation of the demand response is small and this means that it is allowed to make the reduction amount of the power demand small (S514). Incidentally, although described later, the complex control plan is more complicated in control while the demand response is being implemented, is higher in possibility that the power demand which is necessary while the demand response is being implemented may exceed an electric power value on the basis of which the customer applies for implementation of the demand response and, in addition, is more complicated also in control of restoration to a steady state after implementation of the demand response and is larger in failure risk of the facility than the single control plan. For this reason, in a case where the monetary profit which is obtained by implementation of the demand response is small, it is rather preferable to apply for implementation of the demand response with a small amount of the negawatt power by application of the single control plan.

The reception unit 20 determines the DR response amount after preparation of the control plan (S515). The reception unit 20 determines the DR response amount, for example, within a range not exceeding the amount of the negawatt power which is able to be created in the control plan which is prepared in step S513 or step S514. Then, the reception unit 20 applies for implementation of the demand response with the determined DR response amount (S516).

Here, the complex control plan which is prepared in step S513 will be described. It is preferable to control the operations of the plurality of pieces of equipment of the air conditioning facility in order to create a large amount of the negawatt power by implementing the demand response. Therefore, in the complex control plan, the power demand is reduced by combining the following individual control plans with one another. The individual control plans may be preferentially adopted in order of (1) to (4) by taking control easiness, the magnitude of the electric power which is reduced, restoration control easiness and so forth into consideration.

(1) The operation of the cooling tower 412 is controlled to reduce the cooling water temperature.

(2) The temperature of the cold water at the outlet of the refrigerator 401 is increased to increase the supplied water temperature.

(3) The operations of some of the plurality of refrigerators 401 and 419 are stopped to increase the supplied water temperature.

(4) The operations of the valve 406 and the pump 402 to reduce the header-to-header differential pressure and the supplied water amount.

In addition, the power demand while the demand response is being implemented may be reduced by shifting the peak of the power demand with the use of alternative facilities such as an ice thermal storage machine, a water heater, a fuel-type refrigerator and so forth. Further, an individual control plan for stopping the operation of the refrigerator 401 (419) that the reduction in power consumption is possible by operating such alternative facilities as mentioned above may be prepared. In this case, the individual control plan for operating the alternative facilities is added as the individual control plan (5) which is low in priority of adoption.

Next, the single control plan which is prepared in step S514 will be described. In a case where it is allowable to make the amount of the negawatt power to be created by implementing the demand Response small, it is rather preferable to control the operation of one kind of the air conditioning facility from the viewpoint of the control easiness and the restoration control easiness. For this reason, one plan which makes creation of the necessary amount of the negawatt power possible in the individual control plans of (1) to (4) or (1) to (5) is set as the single control plan.

In any of the abovementioned control plans, the rate of operation is reduced and/or the operation of the equipment concerned is stopped by using the indoor warmth data 107 in such an extent that the indoor environment does not become discomfort, that is, in such an extent that it is possible to maintain a sufficiently warm feeling.

FIG. 9 is a flowchart illustrating one example of processing that the calculation unit 30 executes.

When the reception unit 20 determines the DR response amount (S515) and implementation of the demand response is started, the processor 201 activates the calculation unit 30 in accordance with the calculation program and the calculation unit 30 executes the calculation processing.

Then, the calculation unit 30 allocates the processing depending on whether the control plan which is prepared in the reception processing is the complex control plan or the single control plan.

In a case where the control plan which is prepared in the reception processing is the complex control plan, the calculation unit 30 predicts the power demand which will become necessary while the demand response is being implemented in a case of controlling the equipment in accordance with the complex control plan concerned by using the latest measured values of the facility operation data 105 and the indoor warmth data 107 after implementation of the demand response is started (S522). For example, in a case where the demand response is implemented for 30 minutes, a power demand which will become necessary after the elapse of five minutes may be predicted. Linear prediction such as that illustrated in FIG. 7 may be used for prediction.

On the other hand, in a case where the control plan which is prepared in the reception processing is the single control plan, the calculation unit 30 predicts the power demand which will become necessary while the demand response is being implemented in a case of controlling the equipment in accordance with the single control plan concerned by using the latest measured values of the facility operation data 105 and the indoor warmth data 107 after implementation of the demand response is started (S523). For example, in a case where the demand response is implemented for 30 minutes, a power demand which will become necessary after the elapse of five minutes may be predicted.

Thereafter, the calculation unit 30 compares the predicted power demand with the DR response amount and monitors whether the power demand is rapidly increased due to occurrence of an unexpected situation in the building concerned. Then, in a case where the predicted power demand does not satisfy the DR response amount, the calculation unit 30 decides that it is necessary to reduce the power demand at a time that the power demand is predicted and re-prepares the control plan (S524). For example, a control amount of each piece of equipment may be increased and the number of pieces of equipment to be controlled may be increased by changing the control plan from the single control plan to the complex control plan. Incidentally, power consumption of facilities other than the air conditioning facility may be reduced in place of re-preparation of the control plan or in addition to re-preparation of the control plan. For example, lights in a common-use area are dimmed and power consumption of a water supply facility is reduced.

The calculation unit 30 predicts the power demand which will become necessary while the demand response is being implemented and controls so as to keep the DR response amount in this way.

FIG. 10 is a flowchart illustrating one example of processing that the restoration unit 50 executes.

At the termination of implementation of the demand response, the processor 201 activates the restoration unit 50 in accordance with the restoration program and the restoration unit 50 executes the restoration processing.

First, the restoration unit 50 selects a restoration model which is in a similar situation with reference to the facility operation data 105, the indoor warmth data 107, the current meteorological condition 101 and the building past effective management data 104 (S531). The building past effective management data 104 includes the restoration patterns as mentioned before and the restoration unit 50 selects one restoration pattern which is similar in situation from the restoration patterns in the building past effective management data 104 as the restoration model. Incidentally, in a case where the complex control plan is performed while the demand response is being implemented, a pattern for complex restoration control is used as the restoration pattern and in a case where the single control plan is performed, a pattern for single restoration control is used as the restoration pattern.

Thereafter, in a case where the restoration model is a model for complex restoration control, the restoration unit 50 restores the supplied water temperature by restoration of the refrigerator 419 to the normal operation (S532) and restores the cooling water temperature by restoration of the cooling tower fan (S533) in accordance with the selected restoration pattern. Incidentally, in a case where resumption of the operation of the refrigerator 419 and restoration of the valve 414 and a pump 416 are included in the selected restoration pattern, the restoration unit 50 resumes the operation of the stopped refrigerator 419 and restores the valve 414 and the pump 416 to steady operation states. Incidentally, since the power amount is changed depending on the order of restoration, restoration order which is small in power amount may be selected.

On the other hand, in a case where the restoration model is the single restoration control, the restoration unit 50 restores the operation of the equipment whose operation rate is reduced or whose operation is stopped to the normal operation (S534).

Thereafter, the restoration unit 50 starts control according to the restoration model and then verifies the restoration model at predetermined timings (for example, every five minutes in the restoration model which takes 30 minutes) with reference to the facility operation data 105 and the indoor warmth data 107 (S535). In a case where a measured value does not change even when controlling the operation of the equipment in accordance the restoration model, the restoration unit 50 decides occurrence of abnormality in the air conditioning facility and suspends the control according to the restoration model. For example, in a case where the supplied water temperature is not reduced even when instructing to restore the operation of the refrigerator 401 (419) to the normal operation, the restoration unit 50 decides occurrence of abnormality (a failure of the refrigerator 401 (419)). In addition, in a case where the flow rate does not change even when instructing to close the valve 406 (414), the restoration unit 50 decides occurrence of abnormality (a failure of the valve 406 (414) and clogging of a conduit around the valve 406 (414)). Incidentally, restoration of the facility which is decided to be abnormal may be suspended and all the controls of the restoration model may be suspended.

In a case where any abnormality is not detected in verification of the restoration model, the restoration unit 50 restores the air conditioning facility to the steady-state operation and puts the air conditioning facility into operation (S536).

It is possible to realize a commissioning process of performing a more appropriate and energy saving operation in this way.

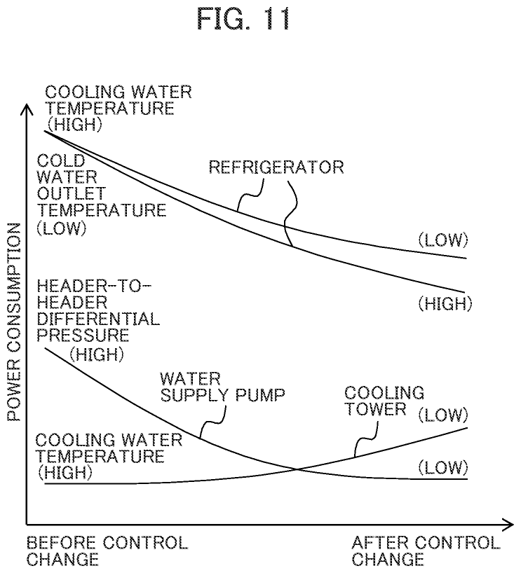

FIG. 11 is a graph illustrating one example of a relation between the operation and the power consumption of equipment to be controlled. The energy management system 1 according to the present embodiment controls the power consumption of the entire system by balancing the operations of the refrigerator 401 (419) (control of the suppled water temperature), the pump 402 and the valve 406 (control of the header-to-header differential pressure and the supplied water amount) and the cooling tower 412 (control of the cooling water temperature) which configure the air conditioning facility. For example, it is possible to reduce the power consumption of the equipment concerned by increasing the supplied water temperature as illustrated in FIG. 11. It is possible to reduce the entire power consumption while maintaining the indoor environment by increasing the pump output so as to increase the supplied water amount simultaneously with the reduction in power consumption of the equipment concerned. In addition, in a case where the cooling water temperature is reduced for improvement of the efficiency of the refrigerator 419, the motive power of the fan of the cooling tower 412 is increased. The power consumption of the entire system may be controlled by taking the above-described matters into consideration.

As described above, the energy management system 1 according to the present embodiment has the prediction unit 10 which determines the effective management pattern 104′ by selecting one effective management pattern which is similar to the current effective management state from the effective management patterns in the building past effective management data 104 (S502) and predicts the DR demand amount on the basis of the weather forecast 102 and the building past effective management data 104 (S504) and the reception unit 20 which prepares the control plan for the air conditioning facility by using the determined effective management pattern 104′ (S513, S514) and determines the DR response amount from the power consumption amount in the control plan concerned (S515). The reception unit 20 prepares at least one of individual control plans for (1) minimizing the sum of the power consumption amounts of the cooling tower 412 and the refrigerator 419 without changing the amount of heat that the refrigerator 419 generates by controlling the operation of the cooling tower 412, (2) improving the efficiency of the refrigerator 401 by increasing the cold water temperature at the outlet of the refrigerator 401, (3) stopping the operation of at least one of the refrigerators 401 and 419, (4) controlling the operations of the valve 406 (414) and the pump 402 (416) to reduce the motive power of the pump 402 (416), and (5) operating an alternative facility and stopping the operation of at least one of the refrigerator 401 and 419, combines the prepared individual control planes with one another in order of the plans (1) to (5) and thereby prepares a control plan which satisfies the predicted DR demand amount. Therefore, it is possible to create the negawatt power by utilizing the air conditioning facility which is large in power consumption and thereby to reduce the power demand. In addition, it is possible to reduce the influence caused by the reduction in power demand and then to implement the demand response. For this reason, it becomes possible for broadly ranging operational divisions to participate in the demand response and to reduce the power demand by implementing the demand response. In addition, in a case where execution of only the individual control plans (1) to (4) is sufficient for attainment of the power consumption reduction, it is possible to reduce the power demand without introducing a new facility such as a large storage battery and so forth.

In addition, the reception unit 20 prepares at least one of individual control plans for (1) controlling the temperature of the cooling water which is sent out of the cooling tower 412 so as to minimize the sum of the power consumption amounts of the fan of the cooling tower 412 and the refrigerator 419, (2) increasing the temperature of the cold water which is sent out of the refrigerator 401, (3) stopping the operation of at least one of the refrigerators 401 and 419 so as to increase the temperature of the cold water, (4) controlling the operations of the valve 406 and the pump 402 so as to reduce the header-to-header differential pressure and the supplied water amount of the cold water, and (5) operating the alternative facility and stopping the operation of at least one of the refrigerators 401 and 419, combines the prepared individual control planes with one another in order of the plans (1) to (5) and thereby prepares the control plan which satisfies the predicted DR demand amount. Therefore, it is possible to reduce the entire power consumption while maintaining the indoor environment.

In addition, the reception unit 20 estimates the power unit price in the demand response on the basis of the weather forecast 102 and demand response past result data (the building past effective management data 104) (S511), decides the magnitude of a profit obtained by implementing the demand response on the basis of the result of comparison between the estimated power unit price and the predetermined threshold value (the standard price) (S512) and prepares the complex control plan for controlling the plurality of pieces of equipment in a case where the obtained profit is large (S513). Therefore, it is possible to more reduce the power demand and to obtain many monetary profits by implementing the demand response.

In addition, the prediction unit 10 determines the effective operation pattern 104′ by selecting one effective management pattern which is similar to the current effective management state from the effective management patterns in the building past effective management data 104 on the basis of the current meteorological condition 101 and the building effective management calendar 103. Therefore, it is possible to determine the suitable effective management pattern without performing complicated calculations.

In addition, the restoration unit 50 performs the control of restoration from the demand response in accordance with the determined restoration model and verifies the operation state of the air conditioning facility on the basis of the operation state (the facility operation data 105) of the air conditioning facility which is being subjected to restoration control and the warmth state (the indoor warmth data 107) which is achieved by the air conditioning facility concerned. Therefore, it becomes possible to realize the commissioning process of performing the more appropriate and energy saving operation. In addition, it becomes possible to appropriately operate the air conditioning facility by deciding the abnormality which occurs while the air conditioning facility is being subjected to the restoration control.

In addition, the calculation unit 30 verifies the operation state of the air conditioning facility while the demand response is being implemented on the basis of the operation state (the facility operation data 105) of the air conditioning facility and the warmth state (the indoor warmth data 107) which is achieved by the air conditioning facility concerned and re-prepares the control plan in a case where the power consumption of the air conditioning facility deviates from the power consumption in the prepared control plan. Therefore, even when the unexpected situation occurs while the demand response is being implemented and the power demand is increased, it becomes possible to satisfy the DR response amount in Accordance with the new control plan.

Incidentally, the present invention is not limited to the aforementioned embodiment and various modified examples and equivalent configurations in the gist of the appended patent claims are included. For example, the aforementioned embodiment is described in detail for easy understanding of the present invention and the present invention is not necessarily limited to the one which includes all the configurations which are described. In addition, part of a configuration of one embodiment may be replaced with a configuration of another embodiment. In addition, a configuration of another embodiment may be added to a configuration of one embodiment. In addition, another configuration may be added to, deleted from and/or replaced with part of one configuration of each embodiment.

In addition, the aforementioned respective configurations, functions, processing units, processing measures and so forth may be implemented in hardware by designing some or all of them by using, for example, an integrated circuit and so forth and may be implemented in software by interpreting and executing a program for implementing each function thereof by a processor.

It is possible to store information on the program, the table, a file and so forth used for implementing each function into a storage device such as a memory, a hard disc, an SSD (Solid State Drive) and so forth and/or a recording medium such as an IC (Integrated Circuit) card, an SD (Secure Digital) card, a DVD (Digital Versatile Disc) and so forth.

In addition, only control lines and communication lines which are thought to be necessary from the viewpoint of description are illustrated and all control lines and communication lines which are necessary from the viewpoint of mounting are not necessarily illustrated. Practically, it may be thought that almost all configurations are mutually connected.

What is claimed is:

1. An energy management system that controls an operation of an air conditioning facility, comprising:
an arithmetic operation device that realizes the following respective function units by executing processing in accordance with predetermined procedures; and
a storage device that is connected to the arithmetic operation device,
wherein the air conditioning facility includes a cooling tower that cools cooling water, refrigerators that cool cold water, a pump that works to circulate the cold water, and a valve that is disposed in a flow path of the cold water,
the energy management system further comprises:
a prediction unit that determines one effective management pattern that is similar to a current effective management state in past effective management data of the air conditioning facility and predicts a DR demand amount on the basis of a weather forecast and the past effective management data of the air conditioning facility; and
a reception unit that prepares a control plan for the air conditioning facility by using the determined effective management pattern and determines a DR response amount depending on a power consumption amount in the control plan as the function units, and
wherein the reception unit prepares at least one of individual control plans for (1) minimizing the sum of power consumption amounts of the cooling tower and the refrigerator without changing an amount of heat that the refrigerator generates by controlling an operation of the cooling tower, (2) improving efficiency of the refrigerator by increasing a cold water temperature at an outlet of the refrigerator, (3) stopping an operation of at least one of the refrigerators, (4) controlling operations of the valve and the pump to reduce motive power of the pump, and (5) operating an alternative facility and stopping the operation of at least one of the refrigerator, combines the prepared individual control plans with one another in order of the plans (1) to (5), and thereby prepares a control plan that satisfies the predicted DR demand amount.

2. The energy management system according to claim 1, wherein the reception unit prepares at least one of individual control plans for (1) controlling a temperature of the cooling water which is sent out of the cooling tower so as to minimize the sum of power consumption amounts of a fan of the cooling tower and the refrigerator, (2) increasing a temperature of the cold water that is sent out of the refrigerator, (3) stopping an operation of at least one of the refrigerators to increase a temperature of the cold water, (4) controlling operations of the valve and the pump to reduce a header-to-header differential pressure and a supplied water amount of the cold water, and (5) operating the alternative facility and stopping the operation of at least one of the refrigerators, combines the prepared individual control plans with one another in order of the plans (1) to (5), and thereby prepares a control plan that satisfies the predicted DR demand amount.

3. The energy management system according to claim 1,
wherein the reception unit
estimates the electric power unit price in demand response on the basis of the weather forecast and past actual result data of the demand response,
decides magnitude of a profit obtained by implementing the demand response on the basis of a result of comparison between the estimated electric power unit price and a predetermined threshold value, and
in a case where the obtained profit is large, prepares a control plan for controlling a plurality of pieces of equipment.

4. The energy management system according to claim 1,
wherein the storage device stores therein a plurality of effective management patterns of the air conditioning facility, and
the prediction unit determines the effective management pattern by selecting one effective management pattern that is similar to the current effective management state of the air conditioning facility from the effective management patterns in the storage device on the basis of a current meteorological condition and the past effective management data of the air conditioning facility.

5. The energy management system according to claim 1, further comprising a restoration unit that determines a restoration model on the basis of the current meteorological condition, an operation state of the air conditioning facility and a warmth state that is achieved by the air conditioning facility, performs control of restoration from demand response in accordance with the determined restoration model, and verifies the operation state of the air conditioning facility on the basis of the operation state of the air conditioning facility that is being subjected to the restoration control and the warmth state that is achieved by the air conditioning facility concerned as the function unit.

6. The energy management system according to claim 1, further comprising a calculation unit that verifies the operation state of the air conditioning facility while demand response is being implemented on the basis of the operation state of the air conditioning facility and a warmth state that is achieved by the air conditioning facility and re-prepares a control plan in a case where power consumption of the air conditioning facility deviates from power consumption in the prepared control plan as the function unit.

7. An energy managing method that an energy management system that controls an operation of an air conditioning facility executes,
wherein the energy management system includes an arithmetic operation device that executes processing in accordance with predetermined procedures and a storage device that is connected to the arithmetic operation device, and
the air conditioning facility includes a cooling tower that cools cooling water, refrigerators that cool cold water, a pump that works to circulate the cold water, and a valve that is disposed in a flow path of the cold water,
the energy managing method comprising the steps of:
determining one effective management pattern that is similar to a current effective management state in past effective management data of the air conditioning facility by the arithmetic operation device;
predicting a DR demand amount on the basis of a weather forecast and the past effective management data of the air conditioning facility by the arithmetic operation device;
preparing at least one of individual control plans for (1) minimizing the sum of power consumption amounts of the cooling tower and the refrigerator without changing an amount of heat that the refrigerator generates by controlling an operation of the cooling tower, (2) improving efficiency of the refrigerator by increasing a cold water temperature at an outlet of the refrigerator, (3) stopping an operation of at least one of the refrigerators, (4) controlling operations of the valve and the pump to reduce motive power of the pump, and (5) operating an alternative facility and stopping the operation of at least one of the refrigerator, combining the prepared individual control plans with one another in order of (1) to (5) and hereby preparing a control plan that satisfies the predicted DR demand amount by the arithmetic operation device in accordance with the determined effective management pattern by the arithmetic operation device; and
determining a DR response amount from a power consumption amount in the control plan concerned by the arithmetic operation device.

8. The energy managing method according to claim 7, wherein the arithmetic operation device prepares at least one of individual control plans for (1) controlling a temperature of the cooling water which is sent out of the cooling tower so as to minimize the sum of power consumption amounts of a fan of the cooling tower and the refrigerator, (2) increasing a temperature of the cold water that is sent out of the refrigerator, (3) stopping an operation of at least one of the refrigerators to increase a temperature of the cold water, (4) controlling operations of the valve and the pump to reduce a header-to-header differential pressure and a supplied water amount of the cold water, and (5) operating the alternative facility and stopping the operation of at least one of the refrigerators, combines the prepared individual control plans with one another in order of (1) to (5), and thereby prepares a control plan that satisfies the predicted DR demand amount.

9. The energy managing method according to claim 7,
wherein the arithmetic operation device
estimates the electric power unit price in demand response on the basis of the weather forecast and past actual result data of the demand response,
decides magnitude of a profit obtained by implementing the demand response on the basis of a result of comparison between the estimated electric power unit price and a predetermined threshold value, and
in a case where the obtained profit is large, prepares a control plan for controlling a plurality of pieces of equipment.

10. The energy managing method according to claim 7,
wherein the storage device stores a plurality of effective management patterns of the air conditioning facility, and
the arithmetic operation device determines the effective management pattern by selecting one effective management pattern that is similar to the current effective management state of the air conditioning facility from the effective management patterns in the storage device on the basis of a current meteorological condition and the past effective management data of the air conditioning facility.

11. The energy managing method according to claim 7,
wherein the arithmetic operation device
determines a restoration model on the basis of the current meteorological condition, an operation state of the air conditioning facility and a warmth state that is achieved by the air conditioning facility,
performs control of restoration from demand response in accordance with the determined restoration model, and
verifies the operation state of the air conditioning facility on the basis of the operation state of the air conditioning facility that is being subjected to the restoration control and the warmth state that is achieved by the air conditioning facility concerned.

12. The energy managing method according to claim 7,
wherein the arithmetic operation device
verifies the operation state of the air conditioning facility while demand response is being implemented on the basis of the operation state of the air conditioning facility and a warmth state that is achieved by the air conditioning facility and
re-prepares a control plan in a case where power consumption of the air conditioning facility deviates from power consumption in the prepared control plan.
